(19) United States
(12) Patent Application Publication
(10) Pub. No.: US 2020/0193404 A1
(43) Pub. Date: Jun. 18, 2020

(54) AN AUTOMATIC IN-STORE REGISTRATION SYSTEM

(71) Applicant: ITAB SCANFLOW AB, Jönköping (SE)

(72) Inventors: Martin ANGENFELT, Jönköping (SE); Johan MÖLLER, Huskvarna (SE)

(21) Appl. No.: 16/468,139

(22) PCT Filed: Dec. 20, 2017
(86) PCT No.: PCT/SE2017/051309

§ 371 Date: Jun. 10, 2019

(30) Foreign Application Priority Data
Dec. 21, 2016 (SE) 1651711-2

(51) Int. Cl. G06Q 20/20; G07G 1/00; B62B 5/00

(52) U.S. Cl. CPC G06Q 20/203; B62B 5/0096; G07G 1/0072; G06Q 20/208

(57) ABSTRACT

A method for registration of an article in a store having at least one article containing area (A-I) and an automatic in-store registration system (100) is provided. The method comprises: associate an accompanying moveable unit such as an article carrying device (5) with a specific registration account (130), wherein the registration account (130) is associated with a dynamic list of articles; continuously monitor the at least one article containing area (A-I) by means of a sensor arrangement (110), and detect a change in the at least one article containing area (A-I) and, in response to said detected change, identify one or more possible articles causing the change in a first identification step and save said one or more possible articles to a temporary article list; continuously monitor the article carrying device (5) by means of the sensor arrangement (110), and detect a change in or near the article carrying device (5) and in response to said detected change identify the article causing the change in a second identification step from the article identities currently included in the temporary article list, and add the article which was identified in the second identification to the dynamic list of articles of the registration account (130).

### TECHNICAL FIELD

The present invention relates to an automatic in-store registration system being configured to automatically registering articles in a store.

### BACKGROUND

In today's stores many different articles, such as food products, hygiene articles, clothing, etc. may be purchased which all have different sizes and shapes, as well as visual appearance. Normally, a checkout operator handles each article manually and makes sure that the article is associated with the correct pricing at checkout for correct payment by the customer. This is traditionally done either by manually inputting the price, by scanning a barcode attached to the article, or a combination of those. However, semi- or fully automatic checkout counters are becoming an interesting alternative for retail stores and supermarkets. Such checkout counters provides robust and easy identification and handling of articles and they normally include different components for identifying the article accurately.

However, in prior art systems the customer still needs to perform the critical step of feeding the articles through a checkout counter in order for the articles to be identified. The customer is required to queue in checkout lines and pass each product from the shopping cart or basket to a scanning system. Therefore, there is a need for an improved registration system that is fast, reliable, and robust and thus has an increased security level while at the same time being easy and convenient for the customer.

### SUMMARY

An object of the present invention is therefore to provide an improved method and system for automatic registration of articles in a store.

According to a first aspect, a method for registration of an article in a store having at least one article containing area and an associated automatic in-store registration system is provided. The method comprises associating an accompanying moveable unit such as an article carrying device with a specific registration account, wherein the registration account is associated with a dynamic list of articles; continuously monitoring the at least one article containing area by means of a sensor arrangement, and detect a change in the at least one article containing area and, in response to said detected change, identify one or more possible articles causing the change in a first identification step and save said one or more possible articles to a temporary article list. The method further comprises continuously monitoring the article carrying device by means of the sensor arrangement, and detect a change in or near the article carrying device and in response to said detected change identify the article causing the change in a second identification step from the article identities currently included in the temporary article list, and adding the article which was identified in the second identification to the dynamic list of articles of the registration account.

The first identification step may be performed by identifying an article by at least using information relating to the position of the change in the article containing area, wherein the position of each one of the plurality of articles arranged in the article containing area is predetermined and accessible for the automatic in-store registration system.

The first identification step may be performed by reducing the total number of possible article identities using the position information of the change in the article containing area.

In an embodiment, the first identification step further comprises determining a signature from an article; and matching the measured signature with a database storing a plurality of reference signatures, wherein each reference signature is associated with a unique article identity.

The second identification step may be performed by reducing the total number of possible article identities using the information saved in the temporary article list.

The second identification step may be performed by accessing the article identities saved in the temporary article list and identifying the article as one of the accessed article identities originally positioned within a predetermined distance from the article carrying device and added to the temporary article list within a predetermined time.

The sensor arrangement may comprise at least one sensor being selected from the group comprising a 2D-camera, a 3D-camera, an IR camera, a scale, a LIDAR sensor, and a spectrometer.

The sensor arrangement may comprise at least two sensors, and the method may further comprise determining a measured article signature using each one of said sensors, and independently comparing each measured signatures with at least a subset of the digital reference signatures associated with the respective sensor.

The method may further comprise combining the result of the comparison in order to determine a single uniquely identified article.

The method may further comprise detecting an incorrect position of an article in an article containing area, and in response to said detection transmit an alarm signal.

The method may further comprise determining a current position of said article carrying device.

The article carrying device may comprise a unique identification tag and the method may further comprise detecting said tag by means of the sensor arrangement, and determining the position of said article carrying device.

The method may further comprise weighing the article carrying device to verify that the weight of the articles arranged therein corresponds to the articles in the dynamic list of articles of the registration account associated with said article carrying device.

According to a second aspect, an automatic in-store registration system in a store having at least one article containing area is provided. The system comprises at least one processor; at least one registration account being associated with a moveable unit such as an article carrying device; and a sensor arrangement comprising a plurality of sensors, the sensor arrangement being configured to, in a first identification step, continuously monitor the article containing area and to detect a change in the article containing area and, in response to said detected change, to transmit a first identification signal comprising information relating to one or more possible articles to the processor. The sensor arrangement is further configured to, in a second identification step, continuously monitor the article carrying device and to detect a change in or near the article carrying device and, in response to said detected change, to transmit a second identification signal comprising information relating to one or more possible articles to the processor; wherein the processor is configured to identify one or more possible articles from the first identification signal and to save said articles to a temporary article list, wherein the processor is further configured to identify one or more possible articles from the second identification signal, to determine a final article by comparing the one or more articles identified from the second identification signal with the articles stored in the dynamic article list, and to add said final article to the registration account.

Preferred embodiments listed above in conjunction with the first aspect are also applicable for the second aspect mentioned above.

According to a third aspect a method for training an in-store registration system configured to identify and register articles in a store having at least one article containing area is provided. The method comprises performing a training sequence in order to improve the accuracy of the identification of articles by: allowing a store attendant to add or remove one or more articles to or from the article containing area, scanning at least one article by a scanning device for identifying the article, registering one or more signatures of each article by means of a sensor arrangement, and adding or updating information relating to signature and the position of each article to the in-store registration system.

The sensor arrangement may comprise at least one sensor being selected from the group comprising a 2D-camera, a 3D-camera, an IR camera, a scale, a LIDAR sensor, and a spectrometer.

The method may further comprise determining the position of the article by means of the sensor arrangement itself, by associating the article position with a unique code which is scanned together with the article code, and/or by means of a position detecting unit provided at the scanning device.

The steps of scanning and registering one or more signatures may be performed using checkout counters, either manually operated, semi-automatic operated, or fully automatically operated.

According to a fourth aspect a method for registration of an article in a store having at least one article containing area and an associated automatic in-store registration system is provided. The method comprises: associate a customer with a registration account; monitor the movement of the customer through the store, continuously monitor the at least one article containing area by means of a sensor arrangement, and detect a change in the at least one article containing area and, in response to said detected change, identify one or more possible articles causing the change in a first identification step and save said one or more possible articles to a temporary article list, wherein, if said temporary article list includes two or more articles, positively identifying the article which caused the change in a second identification step from the articles currently included in the temporary article list; and add the article which was positively identified in the first or second identification to the registration account.

The second identification step may be performed by accessing the article identities saved in the temporary article list and identifying the article as one of the accessed article identities originally positioned within a predetermined distance from the customer and added to the temporary article list within a predetermined time.

The second identification step may be performed by allowing the customer to access the temporary article list by means of an electronic external device having a display, and to positively identify the final article as one of the articles stored in the temporary article list by providing manual input to said electronic device.

The external device may be selected from the group comprising a mobile phone, a tablet, a stationary device arranged in the store.

The method may further comprise identifying a plurality of customers, and associating two or more customers to the same registration account.

The first identification step may further comprise: determining a signature from an article; and matching the measured signature with a database storing a plurality of reference signatures, wherein each reference signature is associated with a unique article identity.

The sensor arrangement may comprise at least two sensors, and the method may further comprise determining a measured article signature using each one of said sensors, and independently comparing each measured signatures with at least a subset of the digital reference signatures associated with the respective sensor.

The sensor arrangement may comprise at least one sensor being selected from the group comprising a 2D-camera, a 3D-camera, an IR camera, a scale, a LIDAR sensor, and a spectrometer.

The first identification step may be performed by identifying an article by at least using information relating to the position of the change in the article containing area, wherein the position of each one of the plurality of articles arranged in the article containing area is predetermined and accessible for the automatic in-store registration system.

The first identification step may be performed by reducing the total number of possible article identities using the position information of the change in the article containing area.

The method may further comprise detecting an incorrect position of an article in an article containing area, and in response to said detection transmit an alarm signal.

According to a fifth aspect an automatic in-store registration system in a store having at least one article containing area is provided. The system comprises at least one processor; at least one registration account being associated with a customer in the associated store; and a sensor arrangement comprising a plurality of sensors, the sensor arrangement being configured to, in a first identification step, continuously monitor the article containing area and to detect a change in the article containing area and, in response to said detected change, to transmit a first identification signal comprising information relating to one or more possible articles to the processor, wherein the sensor arrangement further is configured to continuously monitor the customer; and wherein the processor is configured to identify one or more articles from said first identification signal and to save the identified one or more articles to a temporary article list, wherein if the temporary article list includes two or more articles, the processor is configured to positively identify the article which caused the change in a second identification step from the articles currently included in the temporary article list, and to add the article being positively identified in the first or second identification step to the registration account.

The preferred embodiments mentioned above in conjunction with the fourth aspect are also applicable for the fifth aspect mentioned above.

### BRIEF DESCRIPTION OF THE DRAWINGS

Embodiments of the invention will be described in the following; reference being made to the appended drawings which illustrate non-limiting examples of how the inventive concept can be reduced into practice.

FIG. 1 schematically shows a top view of a store having a registration system according to an embodiment of the present invention;

FIG. 2 shows an isometric view of parts of a store having a registration system according to an embodiment of the present invention;

FIG. 3 shows a schematic view of a registration system according to an embodiment of the present invention;

FIG. 4a shows a schematic method for automatic registration according to an embodiment of the present invention;

FIG. 4b shows a schematic method for automatic registration according to an embodiment of the present invention;

FIG. 5 shows a schematic view of the limitation process of a registration method according to an embodiment of the present invention; and

FIG. 6 shows a schematic method for automatic registration according to an embodiment of the present invention.

### DETAILED DESCRIPTION OF EMBODIMENTS

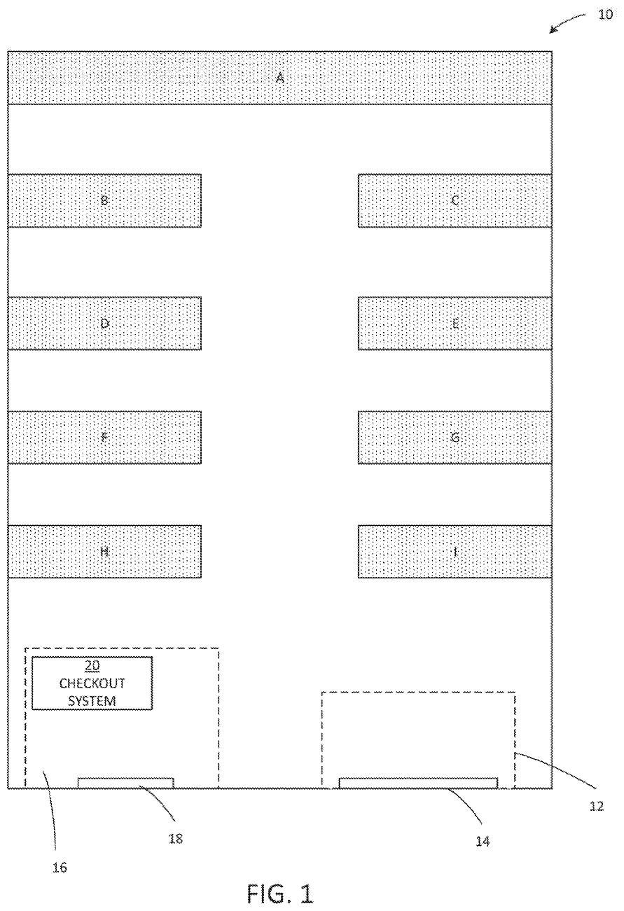

FIG. 1 shows an illustrative view of a designated area, such as a retail or grocery store 10. The store 10 comprises a plurality of article containing areas A-I, such as shelves, displaying articles available for purchase. The store 10 may also include an entrance or check-in area 12, an entrance gate 14, an exit or checkout area 16, an exit gate 18 and at least one checkout station 20. The entrance gate 14 and the exit gate 18 may be the same gate. Furthermore, the entrance area 12 and the exit area 16 may be the same or they may overlap.

A customer enters the store 10 by passing through the entrance gate 14 and into the entrance area 12, whereby the customer walks through the aisles between the article containing areas A-I and collects the articles to be purchased. The article will be, at least in part, identified by the automatic in-store registration system 100 described herein once the article is removed from its original position at the article containing areas A-I. Providing that the identification by the registration system 100 is successful, the customer does not need to scan the article, or provide any other manual input. Once the customer is finished fetching the articles to be purchased, the customer pays the amount corresponding to the chosen articles in the checkout station 20 and exits through the exit area 16 out of the exit gate 18. The total amount to be paid is automatically determined by the registration system 100. The automatic in-store registration system 100 may also use information relating to discounts, coupons, sales-items etc. in the determination of the total amount.

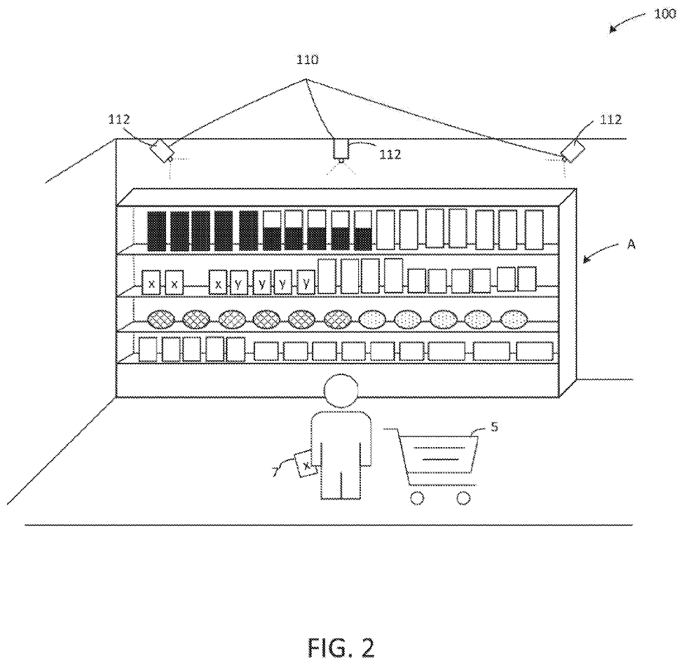

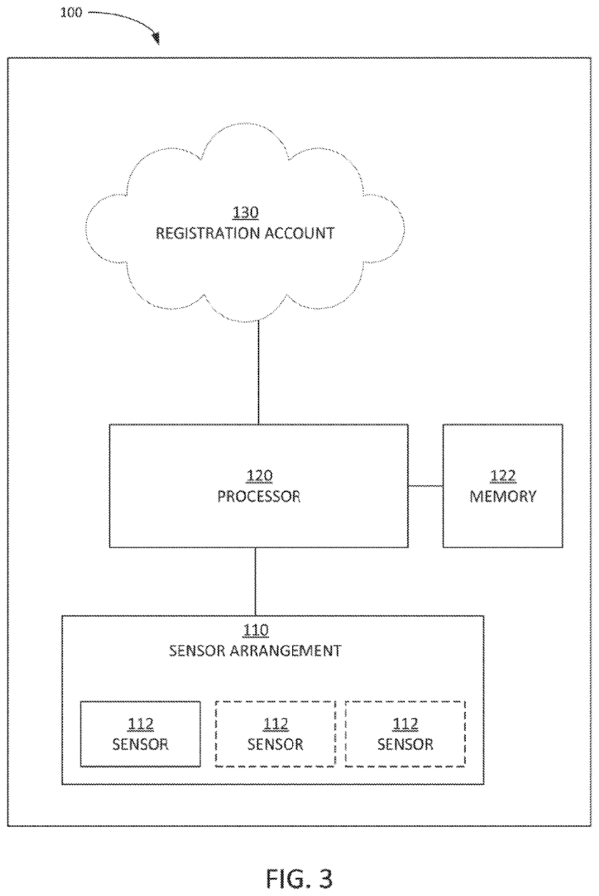

FIG. 2 shows an embodiment of the registration system 100 monitoring one article containing area A, here in the form of a shelf, comprising a plurality of different articles. The registration system 100 comprises a sensor arrangement 110 comprising a plurality of sensors 112, which at least monitors the shelf A per se and/or the articles arranged on the shelf A. In some embodiments, the sensors 112 also monitor a customer 1 and/or an article carrying device 5 used by the customer 1, as will be described in further details below. Furthermore, the registration system 100 comprises a registration account 130, which together with the sensor arrangement 110 will be described more in detail with reference with FIG. 3.

Although the article containing area A shown in FIG. 2 is the form of a shelf, the article containing area may also take the form of a basket, tray, freezer, fridge and/or other similar arrangements which can contain and display articles to a customer. The articles may be of different dimensions, structure and colors as illustrated in FIG. 2. Preferably, all articles being the same type and/or brand are arranged next to each other to facilitate selection and retrieving by the customer 1.

The article carrying device 5 in FIG. 2 is in the form of a shopping cart, but it should be understood that the article carrying device 5 also may be a basket, a bag or similar container which the customer 1 may use to collect and transports its chosen articles. In another embodiment, the article carrying device 5 may be a stationary, but pre-defined area.

In FIG. 2 the customer 1 has fetched an article 7 from the shelf A and has the intention to put down the article into the article carrying device 5. This selected article 7 thus needs to be identified in order to be added to the registration account 130 so that the customer can pay for the article 7. For this purpose the sensors 112 monitor the article containing area A and all the articles arranged thereon, at least the articles arranged at the front. By continuously monitoring the article containing area A, it is possible to recognize when a change in the article containing A has occurred. Such a change may indicate that a customer 1 has picked an article 7 from the article containing area A. The registration system 100 is configured to have access to information relating to which types of articles being present on each article containing A-I and the registration system 100 is configured to use such position information together with analyzing data from the sensors 112 in order to identify the identity of the article 7 being selected and picked by the customer 1.

### The Sensor Arrangement

As explained above the sensor arrangement 110 is provided in order to automatically detect the articles 7 being picked by the customer 1 throughout the store 10. The sensor arrangement 110 thus forms part of the registration system 100, which also, as indicated in FIG. 3, comprises a processor 120, being connected to a memory 122, and a registration account 130 being in operative communication with the processor 120. The sensor arrangement 110 is configured to be in communication with the processor 120 as will be explained further below.

The sensor arrangement 110 comprises at least one sensor 112. However, as indicated by the dotted lines in FIG. 3, the sensor arrangement 110 may comprise a plurality of sensors 112. Preferably, the sensor arrangement 110 comprises a plurality of sensors 112 to create a full coverage of the articles 7 arranged in the store. Furthermore, a plurality of sensors 112 may be arranged to cover different views of the article, so that for example an upper, lower, left, right, front, and back side of the article 7 could be monitored by the sensors 112. The sensors 112 may be arranged on the article container itself, on the walls surrounding the article containers and/or on the ceiling of the store.

Additionally or alternatively, one or a plurality of sensors may be arranged on an article carrying device 5, such as on a shopping cart. If at least one sensor is arranged on a movable article carrying device 5, the sensor can be used to continuously generate data and thus generate a geometry of the store.

The sensor 112 may be configured to provide information corresponding to the dimensions and outer appearance of the article, as well as the position of where the article was picked in the article containing area A-I. The sensor 112 may further provide information relating to size, color, shape, contour, marking with barcode and/or text and/or figure and/or pattern and/or reflection spectrums. The sensor 112 may also provide information relating to weight, movement, different triggers, presence, switching, acceleration, vibration, temperature and/or the picking position in the article container.

The sensor arrangement 110 may preferably comprise different types of sensors 112. The sensors 112 included in the sensor arrangement 110 may for example be any of: a camera, a spectroscopy sensor, a RFID sensor, a contour sensor, a weight sensor (i.e. a scale), a symbol or text recognizing sensor, a color texture sensor, a color histogram sensor, microwave sensor, OCR, 3D-sensor or camera, time of flight sensor, presence sensor, switch sensor, accelerometer, movement sensor, temperature sensor and/or an object sensor and/or microwave sensor and/or a light curtain, an IR camera, and/or LIDAR sensor. The contour sensor, the symbol or text recognizing sensor, the color texture sensor, the color histogram sensor, and the object sensor may all be implemented by one or several cameras that are connected to the processor 120, which processor 120 is configured to execute a specific image-processing algorithm for extracting the required information from the captured images.

In one embodiment at least one sensor 112 in the sensor arrangement 110 is a camera. The camera may be a 2D and/or 3D camera. The camera may have associated image-processing software, or the required processing software may be provided by the processor 120.

The at least one sensor 112 will during operation detect a sensor signal, such as an measured signature, from an article, whereby the processor 120 is configured to match the measured signature with a database of reference signatures. Each reference signature is associated with a unique article identity. Hence, different articles will provide a unique signature whereby an accurate identification may be achieved. The sensor must thus be capable of detecting article signatures for a wide variety of articles having different dimensions. For example, such articles may have small dimensions, as well as large dimensions. The memory unit 122 of the processor 120 may comprises one or more digital reference signatures created by the at least one sensor 112, wherein each one of said reference signature is associated with a corresponding article identity. The identity of the article may be determined by matching a measured signature to a database comprising properties of a plurality of articles. The database may be stored in the memory unit 122 and examples of properties are weight, size, color, shape, contour, pattern, barcode patterns and/or text and/or figure and/or reflection spectrum. In one embodiment, the sensor arrangement 110 comprises at least one sensor in the form of a camera. The camera detects an image from an article, whereby the processor 120 is configured to match the detected image, or a processed digital representation of the image, with a database of reference images, whereby each reference image is associated with a unique article identity. Hence, different articles will provide a unique digital representation of the image whereby an accurate identification may be achieved. The memory unit 122 of the processor 120 may comprises one or more reference images (or reference processed digital representations of the images) created by the at least one camera, wherein each one of said reference images/processed digital representations is associated with a corresponding article identity. The identity of the article may be determined by matching a determined image or a processed digital representation of the image to a database comprising properties of a plurality of articles. The database may be stored in the memory unit 122 and examples of properties are size, color, shape, contour, barcode patterns and/or text and/or figure.

A number of different sensors 112 may be used to provide correct identification of an article. For example, a shelf A is filled with one hundred different article types. Each type of article is represented by a certain number of individual articles, which means that the shelf A stores several hundred, or even thousands of individual articles. There is thus a need for a reliable identification process.

The shelf A may e.g. be equipped with one or more scales forming part of the sensor arrangement 110. When a customer 1 picks an article from the shelf A the total weight of the shelf A will be reduced, and the information relating to the change in weight will be transmitted to the processor 120. If the weight reduction is determined to be 250 g, the processor 120 will determine that the article being picked must belong to one of those article identities not weighing more than 250 g. Preferably, the sensor arrangement 110 may comprise a plurality of scales being positioned at a common shelf A. For example, if a shelf A stores ten different article types, ten individual scales may be provided at the shelf A. Each scale may then be configured to measure the weight of a separate part of the shelf A such that the article type may be identified by detecting a change in weight of the part of the shelf A storing the particular article type. Yet further, the data measured by the scales may further be used to identify the number of articles being picked from the shelf A.

The sensor arrangement may also include one or more LIDAR sensors, which may be attached to a shelf or in the ceiling of the article containing area. The LIDAR sensor is preferably mounted so that it creates a vertical plane in front of an article container, e.g. a shelf A. When a customer or attendant reaches for an article in the shelf A the LIDAR sensor will detect an exact x-y coordinate of where the plane was obstructed. The system may be configured to have information of every unique article's exact position in the shelf A, thus by using the coordinate information from one or more LIDAR sensor the article identity can be accurately determined. The information from the LIDAR sensors may also be used as learning data to the processor 120 when articles are put into the shelf, e.g. as performed when attendants are unpacking new articles for display.

The sensor arrangement 130 may also include one or more IR cameras which may be attached to a shelf or in the ceiling of the article containing area A-I. IR cameras may be specifically advantageous for identifying cold and/or hot articles.

As is evident from the foregoing description, the above example only represents some possible uses of different sensors 112. The above-mentioned description could thus also be implemented using another type of sensor, such as a 3D-camera, a spectrometer, etc.,

### The Communication Interface

The sensor arrangement 110, and thus the individual sensors 112, communicates with the processor 120 by the use of a communication interface. The communication interface is adapted to allow the sensor arrangement 110 to communicate with the processor 120, through the use of different communication technologies. Such communication technologies may be wired or wireless. Examples of such wired technologies are Universal Serial Bus (USB) and Ethernet to name a few. It should be noted that other technologies exist and are taken to be an obvious equivalent for such wired communication interfaces. Examples of such wireless technologies are IEEE 802.11, IEEE 802.15, ZigBee, WirelessHART, WIFI, Bluetooth®, W-CDMA/HSPA, GSM, UTRAN and LTE to name a few. It should be noted that other technologies exist and are taken to be an obvious equivalent for such wireless communication interfaces.

### The Processor

The processor 120, or a plurality of processors 120 arranged in communication with each other, is connected to the sensor arrangement 110. The at least one processor 120 is configured to determine the identity of an article picked by the customer 1. The processor 120 is responsible for the overall operation of the sensor arrangement 120 and the registration account 130 and is preferably implemented by any commercially available CPU (“Central Processing Unit”), DSP (“Digital Signal Processor”) or any other electronic programmable logic device. The processor 120 is configured to read instructions from a memory 122 and to execute these instructions to control the operation of the sensor arrangement 110 and/or the registration account 130. The memory 122 may be implemented using any commonly known technology for computer-readable memories such as ROM, RAM, SRAM, DRAM, CMOS, FLASH, DDR, SDRAM or some other memory technology. The memory 122 is used for various purposes by the processor 120, such as for storing application data and program instructions, as well as storing reference data, such as reference signatures, for the articles of the store 10.

The processor 120 is further connected to the communication interface in order to communicate with the sensor arrangement 120, the registration account 130 and/or an external electronic device (such as a mobile phone, tablet or any other computing device). Such communication technologies may be wired or wireless, as described in relation to the communication interface arranged in the sensor arrangement 110.

### The Registration Account

In some embodiments the registration account 130 is created and connected to the customer in a direct way, i.e. by tracking a customer inside a store, and in some embodiments the registration account 130 is created and connected to an accompanying unit such as an article carrying device 5. The respective embodiments will now be described together with preferred methods of adding identified articles to the registration account.

### Article Carrying Device—Registration Account 1st Embodiment

In some embodiments the registration account 130 is created and connected to an accompanying unit such as an article carrying device. The article carrying device 5 may for example be a shopping cart, basket or a bag.

The registration account 130 keeps a list of the articles that has been collected in the store 10. The registration account 130 is in communication with the processor 120 and during checkout the list of articles is automatically transferred from the registration account 130 to an associated payment system. The registration account 130 comprises a link to an article carrying device 5, represented by means of a unique ID or similar, and a dynamic article list of the items being picked from the article containing areas A-I.

As soon as the person pulls out the article carrying device 5 form its idle location, the article carrying device 5 will be associated with a unique registration account 130. Alternatively, the customer may e.g. press an activation button arranged on the article carrying device 5 or at another position at the entrance area for allowing the article carrying device 5 to be associated with the registration account 130. Association of the article carrying device 5 and the registration account 130 is required in order to make use of the registration system 100. The registration account 130 may either be managed using the article carrying device 5 itself or by connecting the article carrying device 5 to a mobile electronic device, as will be described further below.

In one embodiment, the article carrying device 5 in the form of a shopping cart 5 is used to manage the registration account 130. The shopping cart 5 thus needs to have necessary hardware for allowing the customer to interact with the registration account 130. In one embodiment, the article carrying device 5 may comprise an interactive display and equipment for allowing for manual registration of articles if needed. Such articles may e.g. by bulk articles or similar. The communication interface of the article carrying device 5 may also allow the customer to review and/or mange the registration account 130. It is beneficial if the in-store registration system 100 can gain information of the position of the article carrying device 5. This may be done in several ways. In one embodiment the article carrying device 5 comprises a unique identification tag. This identification tag is read by the sensor arrangement 110, wherein the positions of the individual sensors are known, in order to determine a current position of the article carrying device 5. The identification tag may for example be a QR-code or another unique pattern which can be used for the sensor arrangement 110 to identify the article carrying device 5. In an alternative embodiment the article carrying device 5 may comprise a position detecting unit such as iBeacon, Bluetooth Low Energy (BLE), short-range radio frequency positioning and/or Wifi-based positioning systems.

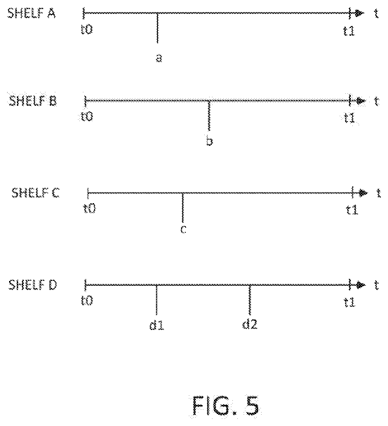

The use of a smart article carrying device 5 allows the registration account 130 to be associated with a current position in the store without tracking the individual customer itself. It can be assumed that the customer picks an article in an article containing area A-I which is within a specified distance from the article carrying device 5. Such presumption reduces the number of possible articles to choose from when identifying a fetched article. This information is used in the identification process of the article, as will be described more in detail with reference to FIG. 5.

Here the customer does not need any other physical device than the article carrying device 5 in order to properly use the registration system 100. Additionally, there is no need for the customer 1 to manually check in when entering the store and multiple customers may use the same article carrying device 5 and thus the same account 130 without requiring adaptation of the registration account 130. Having the registration account 130 associated with an article carrying device 5 has the benefit that the account is not directly associated with the customer and his/her identity.

The embodiment where the registration account 130 is managed using the article carrying device 5 per se is preferably used when the probability of correct identification of an article is very high, so that manual registration is rarely needed.

### Article Carrying Device—Registration Account, 2nd Embodiment

An embodiment in which the registration account 130 is associated with an article carrying device 5 will now be described. In some embodiments, the registration account 130 is managed by connecting the article carrying device 5 to a separate physical device such as an external electronic device. The external device may be a mobile device, such as a mobile phone or other suitable devices for allowing the customer to interact with the registration account 130

In either case, the article carrying device 5 does not need to have any special hardware, display or position detection unit.

As soon as the person pulls out the article carrying device 5 form its idle location, the article carrying device 5 will be associated with a unique registration account 130. Alternatively, the customer may e.g. press an activation button arranged at the entrance area for allowing the article carrying device 5 to be associated with the registration account 130, or use the external device to make the association between the registration account 130 and the article carrying device 5. Association of the article carrying device 5 and the registration account 130 is required in order to make use of the registration system 100.

Preferably, the article carrying device 5 comprises a unique identification tag which the sensors arrangement 120 reads in order to gain the position of the article carrying device 5. Since the positions of the individual sensors in the sensor arrangement are known, it is possible to determine the position of the article carrying device 5. The identification tag may for example be a QR-code or another unique pattern which can be used for the sensor arrangement 110 to identify the article carrying device 5.

When an external device, such as a mobile phone or similar, is used for managing the registration account 130 the article carrying device 5 may be provided with a unique code arranged to be scanned by an application on the external device. Such a code may be in the form of a QR-code, EAN, UPC code or an RFID tag. By scanning the code arranged on the article carrying device 5, the registration account 130 can e.g. be managed using the application of the external device. This allows the customer to manually scan articles using the external device when the registration system 100 does not manage to correctly identify an article, and to manually remove identified articles which for some reason were decided not to be bought. The application of the external device must thus preferably be able to scan codes of an article. The external device may also allow the customer to review and/or mange its registration account 130. For this purpose the external device may e.g. be a dedicated portable code scanning unit.

The tags used by the customer when linking the article carrying device 5 to the registration account 130, and the tag used for identifying the article carrying device 5 by means of the sensor arrangement 110 may not necessarily be the same. In some embodiments, the position of the article carrying device 5 may be determined using a positioning unit on the external device.

The embodiment where the registration account 130 is managed using an external device connected to the article carrying device 5 is preferably used when the probability of correct identification of an article is very high, so that manual registration is rarely needed.

Article Carrying Device—First Identification Step: Limitation

The method of identifying an article 7 once it has been removed from an article containing area A-I will now be described, although already being briefly discussed in the foregoing. The following description is related to the case where the registration account 130 is associated with an article carrying device 5, with or without the use of an external device. As been mentioned above, the sensor arrangement 110 monitors all article containing areas A-I arranged in the store. By continuously monitoring an article containing area A-I, it is possible to recognize when a change in the article containing area A-I has occurred. This may be done by comparing data streams generated by the sensor arrangement 110 and by comparing the data frame by frame.

A change in article containing area A-I may indicate that a customer 1 has selected and removed an article 7 from the containing area A-I. This article 7 needs to be identified in order to be added to the registration account 130 associated with the article carrying device 5. In one embodiment, the first identification step is performed once the system 100 recognizes a change in the article containing area A-I and a second identification step is performed once the customer puts an article into the article carrying device 5.

### Article Carrying Device—First Identification Step: Limitation+Identification

The first identification step comprises two main steps; limitation of possible article identities and identification of a unique article, which steps will now be described more in detail. These two steps may be performed in sequence or simultaneously. The limitation process is based on the fact that the article containing area A-I has a known position in the store and a known range of articles and the limitation process uses this information in order to at least partly identify the article. If an article is removed from one article containing area A, it is a very high probability that said article is one of the articles which usually is accommodated in that article containing area A. This limitation process based on position decreases the number of possible articles.

Once the number of possible articles is reduced, the system 100 needs to narrow down the possible articles to only one unique article. This identification may be achieved using different identification techniques. One such technique may be an identification algorithm, which uses information gathered from the sensor arrangement 110 as an input. The sensor arrangement 110 comprises at least one sensor 112 which is configured to determine a measured signature of the article being taken from the article container. The sensors 112 may be switched on, i.e. activated, in sequences to be able to find beneficial combinations or a partial set of or all the sensors may be active until one of the combinations provides a positive decision, wherein one or more of the redundant sensors may be disconnected. A positive decision is here when all sensors in the combination have detected and identified a predetermined property of an article, where the properties in combination together give the article an identity. The identity may be determined through control against a database comprising properties, or signatures, of an amount of articles. The database may be stored in the memory unit according to what has previously been described. Examples of properties are size, color, shape, contour, marking with barcode and/or text and/or figure and/or pattern. In order to provide a successful classification, an activated sensor determines a measured signature of an article. The measured signature is associated with the sensed signal, and may thus be a digital representation of a number of different article properties. The processor 120 is for this purpose configured to compare the measured signature with the digital reference signatures stored in the memory unit, and to calculate a matching probability of a predetermined number of article identities. The latter step is preferably performed by comparing the measured signature with all, or a subset of, the digital reference signatures of the memory unit and subsequently delivering the article identities having the highest matching probabilities to a further classification algorithm, such as a BBN or a neural network.

In case of using two or more different sensors thus providing two or more different measured signatures, the processor 120 is configured to independently compare each sensors measured signature with all, or a subset of, the digital reference signatures of every sensor. The identified articles and their matching probabilities from two or more sensors are transmitted to the network for further analysis and to combine the highest matching probabilities of each sensor into one combined matching probability.

The articles may also be identified using a pattern recognition algorithm based on the data collected by the sensor arrangement 110. In one embodiment the pattern recognition algorithm is based on SVM, which preferably uses the measured signatures and the digital reference signatures mentioned above as input to the support vector machine model. In an alternative embodiment of the algorithm the system is continuously learned by using the raw data from the sensor arrangement 110. In this situation, the algorithm preferably uses deep learning methods, such as Convolutional neural network or Fully Connected neural network.

The different identification algorithms discussed above may be used separately or as subsequent steps in a combined identification routine. In the latter method the outcome of each step is combined in order to produce a unique identified article with the highest matching probability.

The classification method may further include a step of comparing the highest matching probability with an alarm threshold and, in case the highest matching probability is below the alarm threshold, the system awaits manual input from the customer in the store before proceeding. In one embodiment the identification includes the step of comparing the highest matching probability with two alarm threshold wherein, in case the highest matching probability is above the lowest alarm threshold but below the upper alarm threshold, the method awaits manual input from the customer in the store, and in case the highest matching probability is below the lowest alarm threshold, the system flags the registration account for additional security check at the checkout station. In an alternative embodiment, the attendant is not needed and the customer input is sufficient.

For the embodiments described above the picking position is used to limit the total number of possible articles, and the network is used to further limit the number of possible articles to a single, positively identified article. However, it may also be possible to determine the picking position accurately so that a single article is positively identified using only position data. As explained above, LIDAR sensors may be used to accomplish this. In these situations, it is not necessary to make use of the network for further identification of the article.

For all cases described above the first identification step may result in a single, positively identified article, or a list of possible articles.

### Article Carrying Device—Second Identification Step

The information that an article, identified or unidentified, has been taken from its position in the article containing area A-I may be used in a second identification process either to verify the identification from the first identification step or to provide a complete identification of an article which was only partly identified in the first identification step. The second identification step comprises two main steps; limitation of possible article identities and identification or verification of a unique article. These two steps may be performed in sequence or simultaneously.

The second identification process may be initiated when something is moved inside the boundaries of the article carrying device 5 (seen from above when something is moving within the railing rectangle of the article carrying device 5). Although the first identification process may have succeeded in identifying the article when being removed from the article containing area, the system must also determine to which registration account 130 said article belongs to or if this has already been determined to verify that the article and the registration account 130 belongs to each other.

The limitation process of the second identification step will now be described. FIG. 5 illustrates the relationship between an article in an article containing area A-D and the time at which the customer removes the article from the article containing area A-D. Article containing area A comprises articles named a, article containing area B comprises articles named b, article containing area C comprises articles named c and article containing area D comprises articles named d. In this example, the article containing areas A-D are arranged within the predetermined distance from the article carrying device 5. All articles arranged in the article containing areas A-D are thus possible candidates when limiting the number of possible articles. In order to further narrow down the possible articles during the limitation process, the time at which the article was taken from the article container is used.

All articles that are taken from the shelves A-D will be saved in a temporary list, and will be saved thereon for a predetermined period of time t1 before they are removed from the list. The memory 122 saves information of articles being taken from each article containing area A-D for a predefined period of time t1. The time period allows the registration system 100 to have a limited amount of articles to choose from. Hence, the shorter period of time the less number of possible articles to choose from in the identification process. It may take a while from the time when the customer takes the article from the article container until he/she puts the article into the article carrying device 5. The customer may for example grab a couple of different articles before putting them all into the article carrying device 5. The time t1 needs thus be sufficiently long, so that the article still is among the possible articles during identification even if the customer has been slow in putting the article into the article carrying device 5.

If the article was not identified when picked from the article container, all articles that were within a predetermined distance from said article container will be available in the temporary list.

The registration system 100 keeps track of the position of the article carrying device 5, as previously described. This position information is used to limit the possible article candidates as described with reference to FIG. 5. The possible number of articles may be limited by analyzing the location of the article carrying device 5. Only articles that are in a predetermined distance from the article carrying device 5 will be considered to be candidates when the system 100 operates to identify the chosen article. Thus in the second identification step the registration system 100 will use a modified version of the list generated when an article is taken from the article containing area. The list of possible article candidates available during the second identification step will only comprise information relating to articles that have been removed from article containers within a predetermined distance from the article carrying device 5, and within a predetermined time. The number of possible articles which corresponds to the article that has been placed into the article carrying device 5 is thus greatly reduced.

Hence, the registration system 100 uses the list to identify that the identified article corresponds to the right registration account 130. If there are several possible candidates the registration system 100 identifies the article once the article is placed into the article carrying device 5 in the same or similar manner as the first identification process. The second identification step may be performed when the article is approaching the article carrying device 5, such that the article is moving across a virtual boundary set at a predetermined distance from the article carrying device 5. The virtual boundary may coincide with the physical dimensions of the article carrying device 5.

As with the first identification step, the identification may be achieved using different identification techniques. One such technique may be an identification algorithm, which uses information gathered from the sensor arrangement 110 as input. In the second identification step, the input to the algorithm is taken from sensor(s) arranged such that the sensor(s) oversees the article carrying device 5 in the store. The content of the article carrying device 5 may be analyzed continuously so that it is possible to detect once an article is placed into, or close to the article carrying device 5 as explained above. The at least one sensor 112 collects data from the shopping cart before and after the customer approaches it and it is thus possible to detect when an article has been added or removed from the article carrying device 5. The sensor arrangement 110 may use different identification algorithms in order to identify the articles being arranged in the shopping basket.

If the registration system 100 failed to completely identify the article once removed from the article container, the system 100 gets another chance of identifying the article by analyzing the article carrying device 5 as has been described above. If the article was not identified when picked from the article container, all articles that were within a predetermined distance from said article container will be available in the list.

As soon as the article has been detected and identified, the registration system 100 may determine whether the article was really picked up by the customer or if it was put back in the article containing area A-I. This may be done by analyzing sensor data from the article containing area before and after the customer approached it. It is also possible to use sensor data for searching article specific patterns inside the customers' article carrying device 5. In one embodiment, in case a customer returns an article that is already registered to its account, the registration system 100 recognizes that the identified article that was returned and removes the article from the registration account 130.

Once the registration system 100 has identified the article, and possibly verified that it was actually collected by the customer or added to the article carrying device 5, the article identity is added to the associated registration account 130.

### Article Carrying Device—Adding Weight Priced Articles to a Registration Account

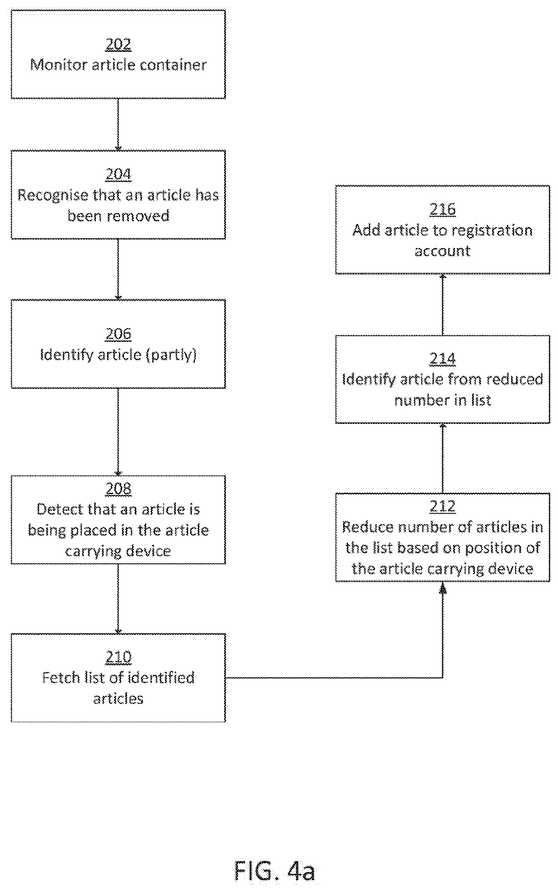

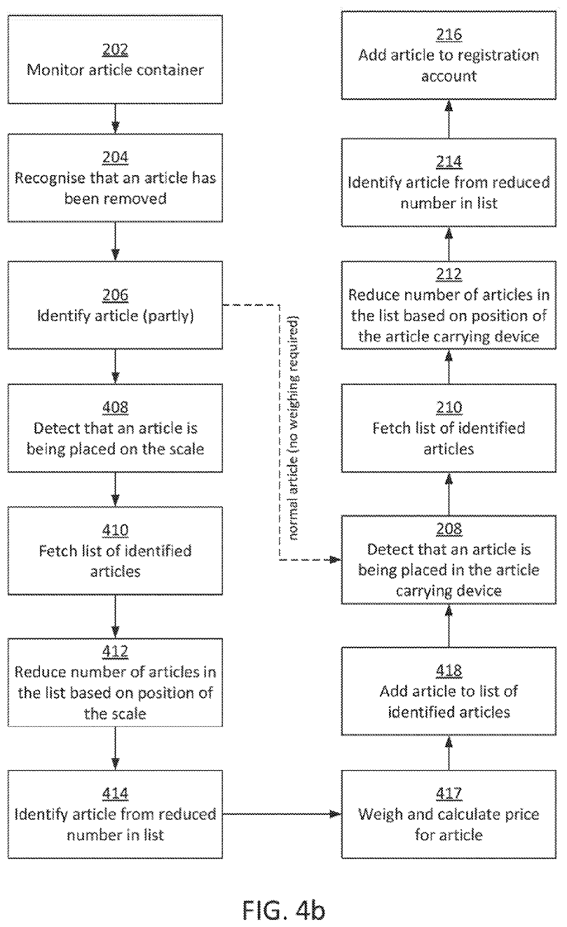

In FIG. 4b a method for adding weight priced articles to a registration account associated with an article carrying device 5 is schematically shown. The following description is related to the case where the registration account 130 is associated with an article carrying device 5, with or without the use of an external device.

In FIG. 4b some of the method steps are identical to the method steps of FIG. 4a. Therefore, these are assigned the same reference numerals.

In a first step 202, the sensor arrangement 110 monitors all article containers A-I arranged in the store. By continuously monitoring an article containing area, it is possible in step 204 to recognize when a change in any of the article containing areas has occurred. Such a change may indicate that a customer has selected and picked an article from the article containing area.

Once the registration system 100 recognizes that an article has been picked by a customer, the registration system identifies the article in step 206. The article may preferably be identified directly as it is removed from the article container A-I, although a 100% proof identification is not required. Instead, this identification step may result in a list of possible articles.

In step 408 the system detects that an article is being placed on an article weighing device located in the store. The article weighing device is preferably forming part of the sensor arrangement 110. This event triggers the following steps. The position of the article weighing device is determined and following this, in step 410 the list of previously identified articles is fetched, and the number of possible articles is reduced by a factor corresponding to the position of the article weighing device. For this, it is possible that all articles being picked by customers are added to the same list of possible articles. This means that as soon as an article is picked from the article containing area, it is added to the list (optionally together with possible alternatives). The articles remain on the list until an article is added to a registration account or it is added to the scale for price calculation by weighing, at which point the article is also removed from the list. Any additional articles that were linked to the positively identified article are also removed from the list.

However, in step 412 the number of articles on the list is reduced in order to determine the correct article. This reduction is however not made permanent to the list, but only used as a selection for the final determination step 414. The reduction of number of articles is made based on the position of the article weighing device, such that only the articles being present on the list and normally belonging to a defined and limited area surrounding the position of the article weighing device is used for the final identification before weighing. In step 414, the correct article is identified based on the reduced number of articles from the list. This final identification before weighing may e.g. be made by monitoring the article weighing device, and determine, by means of the sensor arrangement 110, the correct identity of the article. This step is greatly simplified by only considering the reduced number of possible articles. If the identification in step 414 can't determine a unique article, then the customer selects the correct article on the article weighing device screen. The possible articles to select from can either be the reduced articles from step 412 or all weight priced articles in the store. In step 417 is the article weighed by the article weighing device and the price is then calculated. In step 418 is the article again added to the list of identified articles together with the calculated price and measured weight.

In step 208 the system detects that an article is being placed into an article carrying device 5. This event triggers the following steps. The position of the article carrying device 5 is determined and following this, in step 210 the list of previously identified articles is fetched including the weight priced article that was added in step 418, and the number of possible articles is reduced by a factor corresponding to the position of the article carrying device 5. For this, it is possible that all articles being picked by customers are added to the same list of possible articles. This means that as soon as an article is picked from the article containing area, it is added to the list (optionally together with possible alternatives). The articles remain on the list until an article is added to a registration account, at which point the article is also removed from the list. There is also a possibility, in one embodiment, to track the customers between step 418 and step 208, to simplify the identification when placing the weight priced article into the article carrying device 5.

However, in step 212 the number of articles on the list is reduced in order to determine the correct article. This reduction is however not made permanent to the list, but only used as a selection for the final determination step 214. The reduction of number of articles is made based on the position of the article carrying device 5, such that only the articles being present on the list and normally belonging to a defined and limited area surrounding the position of the article carrying device 5 is used for the final identification. In step 214, the correct article is identified based on the reduced number of articles from the list. This final identification may e.g. be made by monitoring the article carrying device 5, and determine, by means of the sensor arrangement 110, the correct identity of the article. This step is greatly simplified by only considering the reduced number of possible articles. In a final step 216 the article is added to the registration account 130 and the customer is preferably notified that the article has been added to the list of his registration account 130.

If the registration system 100 fails to identify the article correctly, e.g. if a matching probability computed by the registration system 100 is not above a predefined threshold, in step 212 the system 100 notifies the customer to manually identify the article. Once the customer has manually added the article, the article identity is added to the registration account 130.

The user interface e.g. provided by the application of the external device, or by a display arranged on the article carrying device 5, may also allow customers to manually add articles to the registration account without first trying automatic identification. This may e.g. be particularly suitable for bulk goods, whereby the registration system 100 may automatically detect that the customer (i.e. the article carrying device 5) is arranged in an area of the store where bulk goods is present. By such detection, the registration system 100 may prompt the customer to manually input picked articles, whereby these articles are stored in the registration account 130.

### Customer—Registration Account

In the previous, the description has been focused on the embodiments where the registration account 130 is associated with an article carrying device 5. An embodiment where the customer is directly associated with a registration account 130 will now be described. The connection between the registration account 130 and the customer 1 may be done in several ways. In one embodiment the customer 1 is tracked inside the store using image recognition software, such as person tracking system, 3D image tracking from area cameras or other person-tracking algorithms known per se. The sensor arrangement 110 may e.g. be used for providing input data to such positioning. The registration system 100 will therefore know the position of the customer 1 by following the customer as he or she moves around the store 10. Hence, no further position detecting unit may be needed. However, in order to be able to manually register articles and to perform a check-in operation the customer may use some external device associated with the registration account 130.

In one embodiment the customer is connected to a registration account 130 by the use of an external device such as a mobile application on the smart phone or tablet of the customer 1 or any other electronic device carried by the customer.

Once the customer 1 enters the entrance area 12 of the store 10 he or she is associated with a registration account 130. This may be done e.g. by using a fixed unit arranged in the entrance area or on an external device of the customer. In some embodiments, the registration system 100 further identifies the appearance of the customer 1 in the entrance area, which allows the system 100 to track the customer throughout the store.

The registration system 100 needs to determine the position of the customer. This may either be done by the external electronic device of the customer, if it comprises a position detecting unit, or the position of the customer may be determined by direct tracking the customer as the customer walks through the store.

If multiple customers belongs together (such as a family) and arrive to the store at different time it is possible to connect them to the same registration account 130 by manually merging their accounts. Preferably, the merge operation is made by the customers themselves without any interaction with store attendants.

If multiple customers belonging together arrive to the store at the same time, it is desirable if the registration system adds these multiple persons to the same registration account 130. Preferably, automatic recognition of multiple persons shopping together is possible in the check-in area 12. These customers will thus be connected to same registration account 130 during their shopping session. It is also possible to merge accounts inside the store (i.e. in the article container area) by use of the external device.

### Customer—Adding Articles to a Registration Account

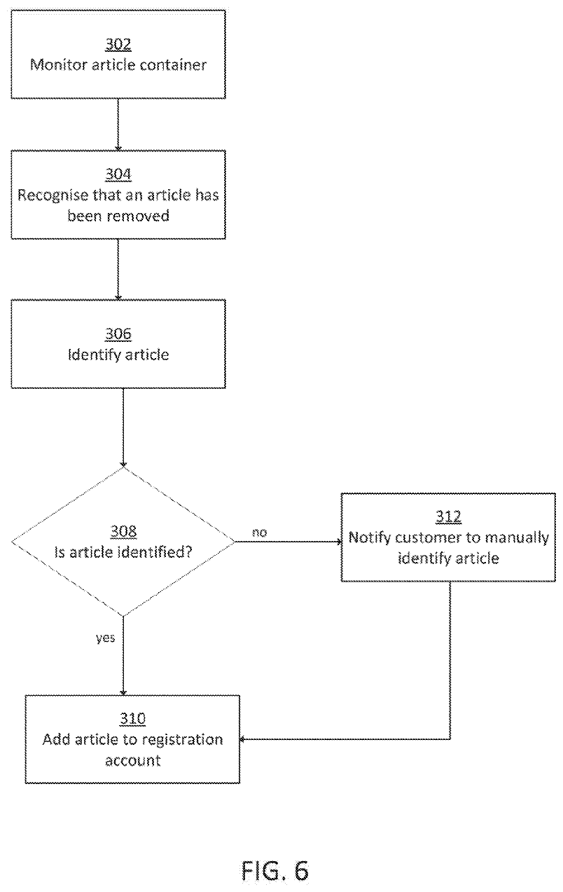

A method of adding an article to a registration account 130 when the registration account is associated with the customer will now be described with reference to FIG. 6. In a first step 302 the sensor arrangement 110 monitors all article containers A-I arranged in the store. By continuously monitoring an article containing area, it is possible in step 304 to recognize when a change in the article containing area has occurred. Such a change may indicate that a customer has selected and fetched an article from the containing area.

Once the registration system 100 recognizes that an article has been picked by a customer, the registration system identifies the article in step 306. The article may be identified directly as it is removed from the article container A-I using the sensor arrangement 110.

If the article was identified, in step 308, as belonging to the customer picking the article from the article container A-I, the article identity is in step 310 added to the registration account 130 associated with that customer. The customer is preferably notified that the article has been added to the list of his registration account 130.

The user interface e.g. provided by the application of the external device may also allow customers to manually add articles to the registration account without first trying automatic identification. This may e.g. be particularly suitable for bulk goods, whereby the registration system 100 may automatically detect that the customer (or associated article carrying device 5) is arranged in an area of the store where bulk goods is present. By such detection, the registration system 100 may prompt the customer to manually input picked articles, whereby these articles are stored in the registration account.

### Customer—First and Second Identification Step

The description relating to the steps of the first identification process for the embodiment where the registration account is associated with the shopping cart are applicable also to the embodiment where the registration account is associated to the customer. However, the number of possible articles may further be limited by analyzing the location of the customer 1. Only articles that are in a predetermined distance from the customer 1 will be considered to be candidates when the system 100 operates to identify the chosen article 7. That distance may be chosen differently depending on the size of the store and the accuracy in determining position of the customer.

In the embodiment where the registration account is associated to the customer the second identification step is somewhat different compared to the situation where the account is associated to an article carrying device 5. If the first identification step is insufficient to identify the article due to a matching probability computed by the registration system 100 being below a predetermined threshold, different options are possible.

According to a first option, in step 312 (see FIG. 6) the system 100 notifies the customer to manually identify the article by scanning a code associated with the article. Once the customer has manually identified the article, the article identity is added to the registration account.

In a second option, the system 100 may in step 312 alert and instruct the customer to manually choose the correct article among a plurality of possible articles. The articles the customer is able to choose from are either the articles that are saved in the reduced article list or a list of articles having high matching probability. The reduced article list is reduced based on the position of the customer, such that only the articles being present on the list and normally belonging to a defined and limited area surrounding the position of the customer is used for the final identification. The customer chooses the correct article identity by using the external device, such as a mobile phone or a tablet. Once the customer has manually identified the article, the article identity is added to the registration account.

In a third option, the customer is not prompted immediately but instead information relating to any unidentified articles is stored in the registration account 130, and the customer will be notified of such unidentified articles during checkout and requested to manually identify those articles. For manual identification, terminals may be provided inside the store for allowing the customer to manually identify articles.

### The User Interface

The interaction between the customer and the registration system 100 is preferably done by the use of a display unit. In one embodiment, the display unit may be in communication with the processor 120 for displaying information regarding the registration account 130. The display unit is preferably arranged for use by a customer for inputting information or for approving the displayed information. The display unit may be arranged at an article carrying device 5 or as an external device, such as a mobile phone of the customer. The display unit may be an interactive display or a passive display having buttons arranged in connection thereto so as to be able to interact with the display. The display may be a LCD-screen, a LED-screen or any other suitable screen.

The information provided in the display unit may for example be information relating to the list of articles that already has been identified as picked by the customer, the total price of the selected articles, offers or deals for different articles in the store and/or accessible information relating to registration customer account such as previous purchase history. For this the customer may have the possibility to link the current registration account 130 with his customer account for the specific store.

The information provided in the display unit may also relate to identification of an article. If the sensor arrangement 110 identifies the article, an image or a text may be shown in the display unit and if the user finds the displayed information matching the article which the customer has chosen the customer may approve the identity by manual input. Further information may be displayed, e.g. weight and price, wherein the user may approve the displayed information if it is correct. The display unit may further notify the customer when an article needs manual registration. This may be the case if the automatic identification of the chosen article fails. The display unit may thus prompt the customer to manually register the article, for example by using a barcode reader or by scanning or identifying the article in some other way.

The display unit may also be used by the customer if the registration system 100 has identified an article which the customer does not want to buy or when the system 100 has identified the article wrongly. The customer may then manually remove the article from the article list of the registration account.

### Incorrect Article Positioning

The system 100 may also be used to ensure the correct position of the articles, for example, if a customer returns an article at an incorrect position. By continuously monitoring the article containing area A-I by the sensor arrangement 110, the automatic in-store registration system 100 may recognize when a customer adds an article back to the article containing area A-I. The system 100 is thus preferably arranged to differentiate between when an article is added or removed from the article containing area A-I. The added article is identified by the registration system 100 and it is determined if the identified article is an article belonging to that position in that article containing area A-I, i.e. in the article containing area A-I that the automatic in-store registration system 100 is trained for.

The article may be added to a different article containing area A-I, if for example the customer picks out an article from the article containing area A and puts it back to another article containing area D, this may for example occur if the customer realizes that the article chosen was in fact not something he/she intended to buy and returns it into a random article containing area D.

If the system 100 determines that the added article was placed in the wrong, position in the correct article container A-I or if the article was placed in the wrong article container A-I, the system 100 will transmit an alarm signal. Preferably, the alarm signal is associated with the position of the article containing area in question whereby it is possible for a store attendant to correct the position of the wrongly arranged article. The alarm signal may also be transmitted to the processor for storing and evaluating the data.

### Payment

Once all the articles of the customer are correctly identified by the registration system 100, and when the customer enters the checkout area 16, the processor 120 transmits a transaction signal to the checkout station or the checkout station can retrieve the account to allow the customer to finish the payment transaction. Once the customer enters the checkout area 16 the information stored in the registration account 130 is automatically transmitted to the checkout station or the checkout station retrieves the account. The checkout station then transfers the registered articles to a receipt for payment.

In one embodiment, the checkout station transmits a control signal to a surveillance system which will be used in the determination whether or not to open a passage gate. A person is in such embodiments only allowed to exit through the gate(s) 18 of the store 10 if the person 1 has paid for its article(s). This is determined based on information from the registration system 100 and information regarding the payment. The system may initiate security check based on abnormal activity of a certain registration account.

### Optional Weight Sensor at Exit

In one embodiment, where the registration account is associated with an article carrying device 5, such as a shopping cart, a bag, basket or the like, a weight sensor may be arranged in the exit area 16 of the store to act as a safeguard to the registration system 100. The weight sensor may either be provided before or after the payment process. The total weight of the article carrying device 5, containing all picked articles, are compared to the estimated weight based on the weight of an empty article carrying device 5 and the total weight of the identified articles or it is compared to a trained weight which is saved in the processor 120 for all possible article carrying devices such as shopping cart, bag, basket or the like. If all articles inside the article carrying device 5 are identified by the registration system 100, the estimated weight and the actual weight shall be equal, or the difference shall be within a small permissible range. If the actual weight does not sufficiently correspond to the estimated weight, such information is transmitted to the processor 120 and the customer and/or a store attendant is alerted.

If the article carrying device 5 has a weight lower than the estimated weight, the registration system 100 has either wrongly identified an article or an identified article has been removed from the article carrying device 5 without being correctly removed from the registration account 130.

If the article carrying device 5 has a weight higher than the estimated weight, the registration system 100 has either wrongly identified an article or an unidentified article has been placed into the article carrying device 5 but not being added to the registration account 130. If an article has been placed in the article carrying device 5 but has not been added to the registration account 130, the customer may then perform manual registration of that article.

### System Learning

The automatic in-store registration system 100 may be subject to training, or learning, in order to improve the accuracy of the identification of articles. For example, the sensor arrangement 110 may be activated during predetermined training sessions, in which a store attendant picks articles in a consecutive order. For each picked article type, the attendant scans at least one article for a secure identification. The system 100 will thus not only learn to identify the article correctly, but also the exact position of the article. For determining the position of the article it is preferred to know the position of the scanner, either by detecting the position by means of the sensor arrangement 110 itself, or by associating the article position (i.e. the shelf or similar) with a unique code which is scanned together with the article code. As a third option the scanner may comprise a position detecting unit such as iBeacon, Bluetooth Low Energy (BLE), short-range radio frequency positioning and/or Wifi-based positioning systems.

System learning may further be improved by using checkout counters, either manually operated, semi-automatic operated, or fully automatically operated.

The training, or learning, may also occur during normal operation of the store, where the store attendant adds or refills articles into the article containing area. For each picked article type, the attendant scans at least one article by a handheld device. The sensor arrangement is thus trained with every single article which the store attendant adds into the article container. Even if the scanner is used only for one or a few articles of each article type, the sensor arrangement 110 can register signatures and position of each article for every article type. The system 100 will thus learn to identify the article correctly by using both the appearance of the article as well as the exact position of the article.

It should be appreciated that even though numerous characteristics and advantages of the present invention have been set forth in the foregoing description, together with details of the structure and function of the invention, the description is only illustrative and changes may be made in detail, especially in matters of shape, size and arrangement of parts within the scope of the invention to the full extent indicated by the appended claims.

1. A method for registration of an article in a store having at least one article containing area and an associated automatic in-store registration system, wherein the method comprises:
associating an accompanying moveable unit such as an article carrying device with a specific registration account, wherein the registration account is associated with a dynamic list of articles;
continuously monitoring the at least one article containing area by means of a sensor arrangement, and detecting a change in the at least one article containing area and, in response to said detected change, identifying one or more possible articles causing the change in a first identification step and saving said one or more possible articles to a temporary article list;
continuously monitoring the article carrying device by means of the sensor arrangement, and detecting a change in or near the article carrying device and in response to said detected change identifying the article causing the change in a second identification step from the article identities currently included in the temporary article list, and
adding the article which was identified in the second identification to the dynamic list of articles of the registration account.

2. The method according to claim 1, wherein the first identification step is performed by identifying an article by at least using information relating to the position of the change in the article containing area, wherein the position of each one of the plurality of articles arranged in the article containing area is predetermined and accessible for the automatic in-store registration system.

3. The method according to claim 2, wherein the first identification step is performed by reducing the total number of possible article identities using the position information of the change in the article containing area.

4. The method according to claim 1, wherein the first identification step further comprises:
determining a signature from an article; and
matching the measured signature with a database storing a plurality of reference signatures, wherein each reference signature is associated with a unique article identity.

5. The method according to claim 1, wherein the second identification step is performed by reducing the total number of possible article identities using the information saved in the temporary article list.

6. The method according to claim 5, wherein the second identification step is performed by accessing the article identities saved in the temporary article list and identifying the article as one of the accessed article identities originally positioned within a predetermined distance from the article carrying device and added to the temporary article list within a predetermined time.

7. (canceled)

8. The method according to claim 4, wherein the sensor arrangement comprises at least two sensors, and wherein the method further comprises
determining a measured article signature using each one of said sensors, and independently comparing each measured signatures with at least a subset of the digital reference signatures associated with the respective sensor, and
combining the result of the comparison in order to determine a single uniquely identified article.

9.-10. (canceled)

11. The method according to claim 1, further comprising determining a current position of said article carrying device.

12. The method according to claim 11, wherein the article carrying device comprises a unique identification tag and wherein the method further comprises detecting said tag by means of the sensor arrangement, and determining the position of said article carrying device.

13. The method according to claim 1, wherein the method further comprises:
weighing the article carrying device to verify that the weight of the articles arranged therein corresponds to the articles in the dynamic list of articles of the registration account associated with said article carrying device.

14. (canceled)

15. An automatic in-store registration system in a store having at least one article containing area, the system comprising:
at least one processor;
at least one registration account being associated with a moveable unit such as an article carrying device; and
a sensor arrangement comprising a plurality of sensors, the sensor arrangement being configured to, in a first identification step, continuously monitor the article containing area and to detect a change in the article containing area and, in response to said detected change, to transmit a first identification signal comprising information relating to one or more possible articles to the processor, and wherein the sensor arrangement is further configured to, in a second identification step, continuously monitor the article carrying device and to detect a change in or near the article carrying device and, in response to said detected change, to transmit a second identification signal comprising information relating to one or more possible articles to the processor;
wherein the processor is configured to identify one or more possible articles from the first identification signal and to save said articles to a temporary article list, wherein the processor is further configured to identify one or more possible articles from the second identification signal, to determine a final article by comparing the one or more articles identified from the second identification signal with the articles stored in the dynamic article list, and to add said final article to the registration account.

16. A method for training an in-store registration system configured to identify and register articles in a store having at least one article containing area, said method comprising performing a training sequence in order to improve the accuracy of the identification of articles by:
allowing a store attendant to add or remove one or more articles to or from the article containing area,
scanning at least one article by a scanning device for identifying the article,
registering one or more signatures of each article by means of a sensor arrangement, and
adding or updating information relating to signature and the position of each article to the in-store registration system.

17. (canceled)

18. The method according to claim 16, further comprising determining the position of the article by means of the sensor arrangement itself, by associating the article position with a unique code which is scanned together with the article code, and/or by means of a position detecting unit provided at the scanning device.

19. (canceled)

20. A method for registration of an article in a store having at least one article containing area and an associated automatic in-store registration system, wherein the method comprises:
associating a customer with a registration account;
monitoring the movement of the customer through the store,
continuously monitoring the at least one article containing area by means of a sensor arrangement, and detecting a change in the at least one article containing area and, in response to said detected change, identifying one or more possible articles causing the change in a first identification step and saving said one or more possible articles to a temporary article list,
wherein, if said temporary article list includes two or more articles, positively identifying the article which caused the change in a second identification step from the articles currently included in the temporary article list; and
adding the article which was positively identified in the first or second identification to the registration account.

21. The method according to claim 20, wherein the second identification step is performed by accessing the article identities saved in the temporary article list and identifying the article as one of the accessed article identities originally positioned within a predetermined distance from the customer and added to the temporary article list within a predetermined time.

22. The method according to claims 20, wherein the second identification step is performed by allowing the customer to access the temporary article list by means of an electronic device having a display, and to positively identify the final article as one of the articles stored in the temporary article list by providing manual input to said electronic device.

23. (canceled)

24. The method according to claim 20, further comprising identifying a plurality of customers, and associating two or more customers to the same registration account.

25.-27. (canceled)

28. The method according to claim 20, wherein the first identification step is performed by identifying an article by at least using information relating to the position of the change in the article containing area, wherein the position of each one of the plurality of articles arranged in the article containing area is predetermined and accessible for the automatic in-store registration system.

29. The method according to claim 28, wherein the first identification step is performed by reducing the total number of possible article identities using the position information of the change in the article containing area.

30.-31. (canceled)

32. An automatic in-store registration system in a store having at least one article containing area, the system comprising:
at least one processor;
at least one registration account being associated with a customer in the associated store; and
a sensor arrangement comprising a plurality of sensors, the sensor arrangement being configured to, in a first identification step, continuously monitor the article containing area and to detect a change in the article containing area and, in response to said detected change, to transmit a first identification signal comprising information relating to one or more possible articles to the processor, wherein the sensor arrangement further is configured to continuously monitor the customer; and
wherein the processor is configured to identify one or more articles from said first identification signal and to save the identified one or more articles to a temporary article list, wherein if the temporary article list includes two or more articles, the processor is configured to positively identify the article which caused the change in a second identification step from the articles currently included in the temporary article list, and to add the article being positively identified in the first or second identification step to the registration account.
